(19) United States
(12) Patent Application Publication
(10) Pub. No.: US 2008/0119292 A1
(43) Pub. Date: May 22, 2008

(54) Bearing Means for a Hand Held Portable Tool Such as a Brush Cutter

(75) Inventors: Marcus Kragner, Huskvarna (SE); Thomas Engvall, Bankeryd (SE); Marcus Falth, Jonkoping (SE)

Correspondence Address: PEARNE & GORDON LLP, 1801 EAST 9TH STREET, SUITE 1200, CLEVELAND, OH, 44114-3108, US

(73) Assignee: HUSQVARNA AB, HUSKVARNA (SE)

(21) Appl. No.: 10/593,510

(22) PCT Filed: Mar. 24, 2005
(86) PCT No.: PCT/SE05/00450

§ 371 Date: Nov. 29, 2007

(30) Foreign Application Priority Data
Apr. 2, 2004 (SE) 0400902-3

(51) Int. Cl. F16C 1/28

(52) U.S. Cl. 464/52

(57) ABSTRACT

This invention relates to a bearing means for a hand held portable tool such as a brush cutter, a trimmer or the like said means comprising an elongated bearing sleeve (13) that is provided with outwardly extending flanges (14) or the like. The bearing sleeve (13) has a non circular inner surface.

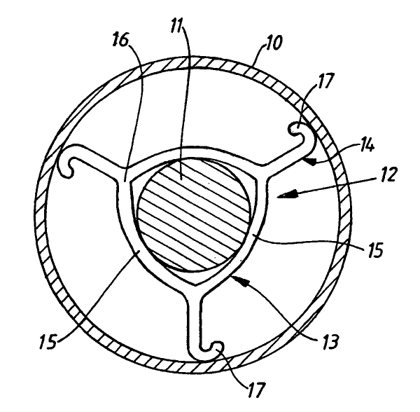

This invention relates to a bearing means for a hand held portable tool such as a brush cutter, a trimmer or the like said means comprising an elongated bearing sleeve that is provided with outwardly extending flanges or the like.

Bearing means of the type mentioned above are used to support elongated drive shafts that transmit forces from a driving unit to a remote cutting tool that is placed at the outer end of a tube shaped casing. Such bearing means are for instance described in U.S. Pat. No. 5,364,307, U.S. Pat. No. 5,599,233 and DE 3839548 and comprises an elongated sleeve with a circular cross section having outwardly extending flanges that rest against the surrounding casing. In order to make it possible to insert the bearing means into the casing and simultaneously avoid any play and keep the bearing sleeve in a central position when the drive shaft rotates the flanges are resilient. This means that the flanges as well as the sleeve have to be designed carefully since a flange that is too soft does not work properly with respect to the vibrations caused by the drive shaft whereas, if the flanges are too hard, the bearing means is difficult to insert into the casing.

The purpose of this invention is to create a new type of bearing means making it possible to decrease the vibrations on the casing caused by the drive shaft and to optimize the design and material thickness of the bearing means. Further the arrangement allows diametrical variations of the drive shaft as well as of the casing substantially without influencing the inner shape of the sleeve. An additional advantage is that the shape of the bearing means makes it possible to achieve a better lubrication than previously.

An embodiment of the invention will now be described with reference to the accompanying drawing that shows a cross section of the bearing arrangement with the bearing means, the drive shaft and the casing.

The bearing arrangement comprises an outer elongated tubular casing 10 that at one end is provided with drive means such as a combustion engine (not shown) or an electric motor whereas the other end of the casing is provided with some type of cutting tool such as a chain saw or a trimmer head (not shown). The power from the drive means is via a drive shaft 11 transferred to the cutting tool. The drive shaft is surrounded by a bearing means 12 that comprises a bearing sleeve 13 with several flanges 14 extending radially outwards from the sleeve.

The bearing sleeve, which preferably is made of plastic and is integrated with the flanges, has a mainly triangular shape with three slightly curved wall portions 15 that are joined to one another at their ends to define the tips 16 of the triangle. Consequently the distance between the inner wall of the sleeve 13 and a circle inscribed in the sleeve increases from the mid part of each wall portion 15 towards the tip 16 of the triangle.

The flanges 14 are placed at the tips 16 of the triangle and are at their outer ends provided with a hook shaped outer portion 17. These hook shaped portions safeguard that manufacturing shrinkage occurs at the tip portion of the hook which means that the outer shape of the detail is diametrically stable.

In order to assemble the bearing arrangement the bearing means 12 is pushed into the tube casing 10 from one of its ends which means that the hook shaped portion 17 of the flanges 14 will come into engagement with the casing and cause the flanges to move somewhat inwards thereby compressing the sleeve 13 at the tips 16 of the triangle such that the complete bearing means can be pushed into the casing. The resilient forces of the sleeve will then keep the bearing sleeve in the right position in the casing and the drive shaft can than easily be inserted into the bearing sleeve.

It is of course also possible to use other geometric configurations of the cross section of the bearing sleeve such as square, pentagonal, hexagonal and so on and to place the flange at such point where the inner surface is at a distance from the inscribed circle such that the material of the sleeve serves as a spring for the radial movement of the flanges.

1. Bearing means for a hand held portable tool such as a brush cutter, a trimmer or the like said means comprising an elongated bearing sleeve (13) that is provided with outwardly extending flanges (14) or the like, said bearing sleeve (13) has a non circular inner surface, characterized in that the flange material and the sleeve material have such characteristics that radial forces acting on the flanges (14) and that are directed towards the center of the sleeve (13) is transferred to resilient deflections of the sleeve (13).

2. Bearing means according to claim 1, characterized in that at least one of the flanges (14) extend from the bearing sleeve at a point where the inner surface is positioned at a distance from a circle that is inscribed in the inner periphery of the sleeve.

3. Bearing means according to any of the proceding claims characterized in that the sleeve (13) has a mainly triangular shape.

4. Bearing means according to claim 3, characterized in that a flange (14) extends mainly radically outwards from each tip (16) of the triangle.

5. Bearing means according to claim 1, characterized in that the outer part of at least one of the flanges is provided with a hook shaped portion (17).
